(19) United States
(12) Patent Application Publication
(10) Pub. No.: US 2007/0189828 A1
(43) Pub. Date: Aug. 16, 2007

(54) Printing Apparatus

(75) Inventor: Mark Smith, Leicestershire (GB)

Correspondence Address: FISH & RICHARDSON PC, P.O. BOX 1022, MINNEAPOLIS, MN, 55440-1022, US

(73) Assignee: MARKEM TECHNOLOGIES LIMITED, Nottingham (GB)

(21) Appl. No.: 11/672,636

(22) Filed: Feb. 8, 2007

(30) Foreign Application Priority Data
Feb. 15, 2006 (GB) 00603020.9

(51) Int. Cl. B41J 2/315

(52) U.S. Cl. 400/120.1

(57) ABSTRACT

A printing apparatus includes a substrate storage module including first and second sides, and a printing module, the storage module including a store of substrates to be printed upon, and a transport mechanism for transporting the substrates to the adjacent printing module, and the printing module including a print head, a ribbon supply spool, a ribbon take-up spool, and ribbon drive mechanism for driving the ribbon relative to the print head, and wherein the printing module is locatable end operable when located at or adjacent either of the first and second opposite sides of the storage module.

### BACKGROUND OF THE INVENTION

The invention relates to a printing apparatus and more particularly a printing apparatus of the kind having a print head which in use removes marking medium from a ribbon carrying marking medium, and deposits the marking medium onto a substrate.

Such printing apparatus typically are used in a production or packaging facility to print information on a patch, such as a label or RFID tag, which is then fed to a patch applying device which applies the patches to articles which are conveyed past the printing apparatus.

As will be appreciated by those skilled in the art, such printing apparatus typically are constructed and/or configured for right hand or left hand use i.e. at one or other side of the conveyor, so that patches are printed and then applied to one or other side of the article. Conventional printing apparatus cannot be used or at least cannot readily be used without major reconfiguration, on either side of a conveyor.

### SUMMARY OF THE INVENTION

According to a first aspect of the invention we provide a printing apparatus including a substrate storage module including first and second sides, and a printing module, the storage module including a store of substrates to be printed upon, and a transport mechanism for transporting the substrate to the printing module, and the printing module including a print head, a ribbon supply spool, a ribbon take-up spool, and ribbon drive mechanism for driving the ribbon relative to the print head, and wherein the printing module is locatable and operable when located at or adjacent either of first and second opposite sides of the storage module.

Desirably the storage module includes a first connector part at each of the first and second opposite sides, and the printing module includes first and second surfaces which are positionable at or adjacent respective first or second sides of the storage module, each of the first and second surfaces including second connector parts which are each engageable with a respective first connector part to enable the printing apparatus to be operated with the printing module at either side of the storage module. The connector first and second connector parts when engaged may permit of electrical continuity between the storage and printing modules, for control purposes and if desired, to provide continuity of electrical power supply.

A controller to control the functions of each of the storage module and the printing module may thus be provided in one or other of the modules, preferably in the storage module.

In accordance with the invention the printing apparatus may thus be readily configured for right hand or left hand use with respect to, for example, an article being conveyed at the production or packaging facility, by locating the printing module with respect to the storage module, at the first or second side thereof, and engaging first and second connector parts to make electrical connections.

In addition to the connector parts, each of the first and second storage module sides may include a first mounting formation and each first and second printing module surface may include a second mounting formation, first and second mounting formations being co-operable for mounting the printing module with respect to the storage module at or adjacent one or other of the first and second sides of the storage module.

Thus the printing apparatus may be mounted at its location at or adjacent the first or second side of the storage module as desired.

Although the invention is applicable to any apparatus of the kind in which the printing module includes a print head which in use removes marking medium from a ribbon carrying marking medium, and deposits the marking medium onto a substrate, the invention is particularly applicable where the print head is of the thermal kind, including an array of printing elements which may be selectively energised under computer control to heat up and to remove pixels of marking medium from the ribbon.

In this case the print head may be mounted so that the print head may be orientated in a first position when the printing module is located at or adjacent the first side of the storage module, and orientated in a second position when the printing module is located at or adjacent the second side of the storage module. Preferably the print head mounting permits of the ready re-orientation of the print head so that the printing apparatus may readily be re-configured for operation at the other of the second and first sides of the storage module.

The printing module may include a backing member, such as a backing roller, to support the substrates during printing.

In one preferred embodiment, the substrates are patches such as labels or RFID tags which each have a face provided with adhesive by which the patches are releasably adhered to an elongate backing web. The patches and backing web may be stored on a storage device such as a storage spool of the storage module, and the patches may be transported, on the backing web to the printing module where the patches are printed upon by the print head.

The printing module may include a patch removal mechanism for removing patches from the backing web after printing, which mechanism may include a reversing roller and/or a beak as is well known in the art. The backing web from which patches have been removed may then be taken up onto a take-up device such as a take-up spool of the storage module.

In one example, the backing web and patches may be transported by rotating the take-up spool although the storage spool may simultaneously be rotated to provide for tension control in the backing web. In another example through, the backing web and patches may be transported by driving a capstan roller about which the backing web is entrained. Further alternatively the transport mechanism may include a shuttle to transport the patches and backing web, as required.

The printing apparatus may include a patch applying module which may be located relative to the printing module to receive printed patches and to apply them to articles.

The patch applying module may include a first connector part which is in use, engaged with the second connector part of the printing module which is not engaged with a first connector part of the storage module.

According to a second aspect of the invention we provide a method of reconfiguring a printing apparatus of the first aspect of the invention which is configured for use with the first surface of the printing module at or adjacent the first side of the storage module, the method including relocating the printing module so that the second surface of the printing module is at or adjacent the second side of the storage module.

The method may include disengaging a first connector part of the first side of the storage module from the second connector part at the first surface of the printing module, and after or upon relocating the printing module, engaging the second connector part of the second surface of the printing module with the first connector part of the second side of the storage module.

The method may include re-positioning the print head.

### BRIEF DESCRIPTION OF THE DRAWINGS

Embodiments of the invention will now be described with reference to the accompanying drawings in which:

FIG. 1 is an illustrative view of a printing apparatus in accordance with the first aspect of the invention;

FIGS. 2a and 2b are respectively, enlarged detailed illustrative drawings of a printing station of the apparatus of FIG. 1, showing the print head in two alternative positions.

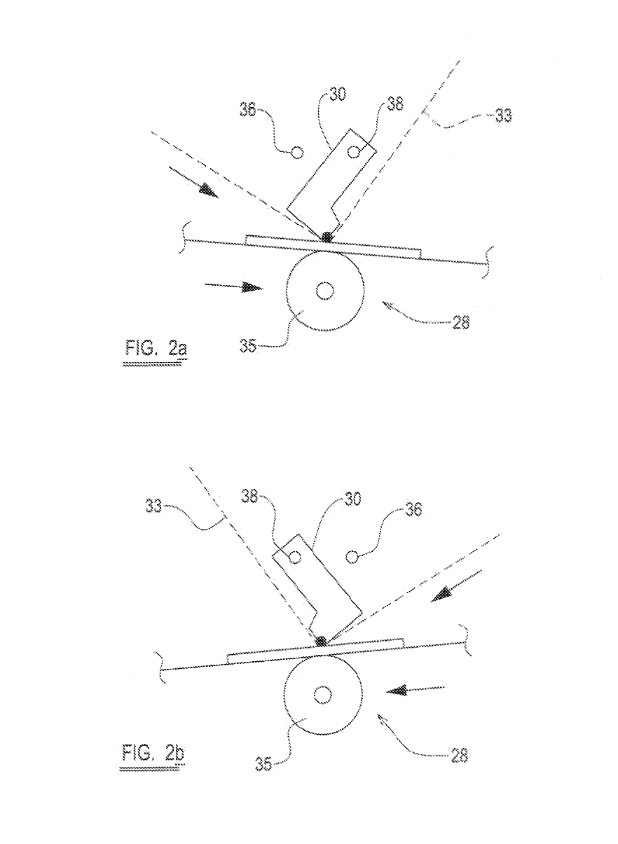

### DESCRIPTION OF THE PREFERRED EMBODIMENTS

Referring to the drawing a printing apparatus 10 includes a storage module 12 and a printing module 14. In the drawing the printer module 14 is shown in full lines located with a first surface 15 thereof, located at or adjacent a first side 16 of the storage module 12, and in dotted lines the printer module 14 is shown located with a second surface 18 thereof, which is opposite to the first surface 15, at or adjacent a second side 19, which is opposite to the first side 16, of the storage module 12.

The storage module 12 includes a store of substrates 20, which in this example are labels each having a face provided with an adhesive by which the labels 20 are all releasable adhered to a face of an elongate backing web 21, which backing web 21 face may be waxed or otherwise treated so that the labels 20 may readily be removed from the backing web 21.

The store of backing web 21 and labels 20 is provided by a label storage spool 23 which is mounted on a mounting spindle 23a, and from which backing web 21 and labels 20 may be paid or drawn out, for example by rotating a take-up spool 24 which is mounted on a mounting spindle 24a, and onto which take-up spool 24, backing web 21 from which labels 20 have been removed, is taken up. If desired both the take-up 24 spool and the storage spool 23 may be rotated simultaneously by appropriate drive means, such as for example conveniently, one or a pair of drive motors.

The storage 23 and take-up spool 24, their mounting spindles 23a, 24a and the drive means, are each parts of a substrate transport mechanism, by which the labels 20 are fed to the printing module 14 for printing. Another alternative transport mechanism could include a capstan drive roller around which the backing web 21 may be entrained, the capstan roller being driven to effect label transport and feeding to the printing module 14, or yet another transport mechanism could include a shuttle.

It can be seen in the drawing, that with the printer module 14 in its full line position, the storage spool 23 rotates anti-clockwise to pay out the backing web 21 and labels 20, whilst the take-up spool 24 rotates anti-clockwise to take-up the backing web 21. With the printer module 14 in its alternative dotted line position though, the storage spool 23 rotates clockwise to pay out the backing web 21 and labels 20 whilst the take-up spool 24 rotates clockwise too, to take-up the backing web 21.

In each case, the transport mechanism may include one or more guide rollers 25 to guide the backing web 21 during transport both to and from the printing module 14.

The printing module 14 includes a printing station 28 where a print head 30 is provided. The print head 30 in this example is a thermal print 30 having an array 31 of printing elements each of which is selectively individually energisable under computer control. When energised, the printing elements of the array 31 heat up, to remove individual pixels of marking medium, i.e. ink, from a carrier ribbon 33. The carrier ribbon 33 is positioned between the print head 30 and a label 20 to be printed upon, whilst the label 20 at the printing station 28 is supported by a backing roller 35. The removed pixels of ink are thus transferred to the label 20 to effect printing as the label 20 moves through the printing station 28.

The print head 30 requires that fresh ribbon 33 from which pixels of marking medium have not previously been removed, is continuously presented to the print head 30. Thus the ribbon 33 is moved through the printing station 28 with the substrate label 20, at the same or a differential speed to the labels 20, and desirably in the same direction.

Ribbon 33 movement is achieved, as the printing module 14 includes a ribbon supply spool 35 mounted on a mounting spindle 35a, and a used ribbon take-up spool 36 mounted on a mounting spindle 36a, and various guide rollers 39a, 39b to guide the ribbon 33. The take-up spool 36 may be rotated by a ribbon drive means such as an electric motor, to draw ribbon 33 from the supply spool 36, or both the take-up 36 and supply spools 35 may simultaneously be driven by respective drive means to move the ribbon 33 through the printing station 28. In another example, a capstan drive arrangement may be employed to drive the ribbon 33.

It can be seen in the drawings that where the printer module 14 is in its full line position shown, two of the ribbon 33 guide rollers 39a are redundant, whilst when the printer module 14 is in its dotted line position, those guide rollers 39a are in use, but the other ribbon guide rollers 39a are redundant.

The print head 30, being of the thermal kind, operates preferentially in an orientation depending upon the direction of feed of the label 20 and ribbon 33 past the print head 30. Thus with the printer module 14 in the full line position in the drawings, the print head 30 is mounted in first orientation, whilst when the printing module 14 is in its dotted line position, the print head 30 is mounted in a second orientation.

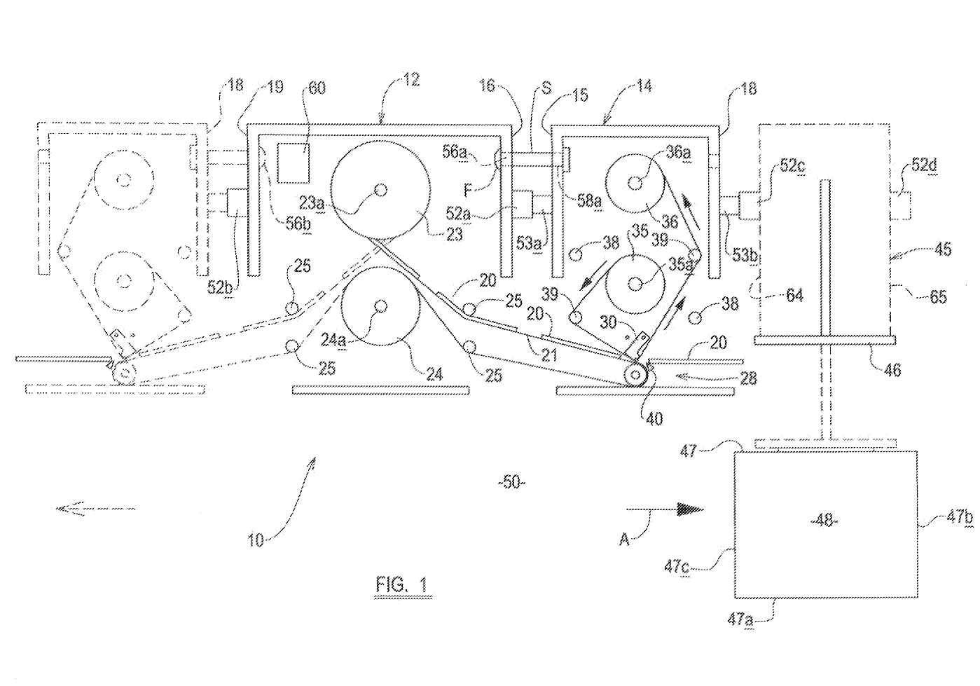

The printer module 14 thus includes at the printing station 28, a print head mounting provided by first and second print head mounting formations 36, 38. When the print head 30 is in the first orientation with respect to the backing roller 35, as shown in full lines in FIG. 1, the print head 30 is positioned so as to be mounted on the first head mounting formation 36, and the second head mounting formation 38 is redundant. When the print head 30 is in its second orientation with respect to the backing roller 35, as shown in dotted lines in FIG. 1, the print head 30 is positioned so as to be mounted on the second head mounting formation 38 and the first head mounting formation 36 is redundant.

The printing module 14 further includes a label removing mechanism provided by a reversing roller, which in the present example is provided by the backing roller 35, and a beak 40. Immediately after a part of the label 20 is printed upon by the print head 30, the backing web 15 is constrained to pass around the backing roller 35. This turn, together with the action of the beak 40 which provides a sharp discontinuity, encourages peeling of the label 20 which is less flexible than the backing web 21, and as a result the label 20 is peeled from and hence removed from the backing web 21 and is fed from the printing module 14, for example, to an adjacent label applying module 45 which is indicated in dotted lines, at or adjacent the second surface 18 of the printing module 14.

The label applying module 45 includes an applicator surface 46 which may be moved linearly by an actuator an indicated, to apply the label 20 to a side 47 of an article 48, such as a package 48 which is conveyed past the printing apparatus 10 on a conveyor 50 e.g. in the direction indicated at A.

Each of the first and second sides 16, 19 of the storage module 12 includes a first connector part 52a, 52b respectively. Each of the first surface 15 and second surface 18 of the printing module 14 includes a second connector part 53a, 53b.

Each of the first and second sides 16, 19 of the storage module 12 includes first mounting formations 56a, 56b provided by openings in side walls thereof. Each of the first surface 15 and second surface 18 of the printing module 14 includes a second mounting formation 58a, 58b.

With the printer module 14 in the full line position of FIG. 1, the first mounting formation 56a of the first side 16 of the storage module 12, co-operates via fasteners F and spacers S to mount the printing module 14 at or adjacent the first side of the storage module 12, with the first connector part 52a on the first side 16 of the storage module 12 engaged with the second connector part 53a of the first surface 15 of the printing module 14.

The storage module 12 includes a controller 60. The engaged connector parts 52a, 53a permit of electrical continuity between the storage 12 and printing modules 14 i.e. the controller 60 may control the operating function of the printer module 14, including co-ordinating the operation of the printer module 14 with the storage module 12.

In the example shown, the label applying module 45 has first connector parts 52c, 52d provided on opposite faces 64, 65 thereof, and the first connector part 52c on the face 64 located at or adjacent the second surface 18 of the printing module 14 being engaged with the second connector part 53b provided on the second surface 18 of the printer module 14, thus to provide electrical continuity between the printer module 14 and the label applying module 45. Thus the label applying module 45 may be controlled by the controller 60 of the storage module 12 too.

As will be appreciated by those skilled in the art, the printing apparatus 10 configured as seen in full lines in FIG. 1, is handed, i.e. the printing apparatus 10 as configured is operable at the left side of conveyor 50 only.

It if is desired to apply labels 20 to an opposite side 47a of the article 48, the printing apparatus 10 needs to be re-located at the right side of the conveyor 50 and the printing apparatus 10 requires to be reconfigured.

Re-handing of the printing apparatus 10 may readily be achieved as follows.

First, the respective storage 12, printing 14 and where provided label applying 45 modules need to be separated. The fasteners F which are received in the mounting formations 56a, 58a of the storage 12 and printing 14 modules will need to be released, and the engaged connector parts 52a, 53a of the storage and printer modules 12, 14 and the engaged connector parts 53b, 52c of the printer and label applying module 45 need to be disengaged too. Preferably all of the connectors are provided by simple plug-in type connector parts which thus are readily disengageable.

The modules 12, 14, 45 may then be repositioned at the right side of the conveyor 50 and reassembled as follows.

The printing module 14 is relocated so that the second surface 18 thereof is at or adjacent the second side 19 of the storage module 12 as indicated in dotted lines in FIG. 1. The fasteners F and spacers S are received in the now adjacent co-operating formations 56b, 58b and the connector parts 52a, 53b on the respective second side 19 and second surface 18 are engaged. The thus engaged connector parts 56a, 58b again provide electrical continuity between the storage 12 and printing modules 14 to enable the printer module 14 to be controlled operationally by the controller 60 of the storage module 12.

The storage spool 23 of the storage module 12 is re-oriented on its mounting spindle 23a, as may be the take-up spool 24 to its mounting spindle 24a, so that the backing web 21 and labels 20 are fed by the transport mechanism to the printer module 14 now located at or adjacent the second side 19 of the storage module 12.

Moreover the ribbon supply spool 35 of the printing module 14, and if desired the ribbon take-up spool 36 may be re-oriented on their respective mounting spindles 35a, 36a to enable the ribbon 33 to be fed to the printing station 28 in the same direction as the labels 20.

Finally, the print head 30 needs to be repositioned on head mounting formation 38 for operation as described above.

If desired, the label applying module 45, where provided, may be located at or adjacent the first surface 15 of the printing module 14, and the first connector part 52d on the second face 65 of the label applicator module 45, engaged with the second connector part 53a on the first surface 15 of the printer module 14 again to provide electrical continuity and to permit the label applying module 45 to be controlled by the controller 45.

It will be appreciated that by virtue of the modular storage modular 12 and printer module 14 approach of the present invention, the printer apparatus 10 described may readily be re-handed.

Various modifications may be made without departing from the scope of the present invention.

For example, the label applying module 45 described is purely exemplary. In another embodiment, the label applying module 45 may be of the kind which in use applies a label 20 to a front 47b of the article 48, or to a rear 47c thereof, in which case the applicator surface 46 may be arranged respectively to swing into the path of or behind an article 48 being conveyed. If desired a second label applying module may be provided, located at or adjacent the first mentioned label applying module 45 so that labels may be applied to both a side and a front or rear of an article 48, if required.

The use of the printing apparatus 10 described to print labels 20 is exemplary, and the printing apparatus 10 may be arranged to print on other patches, such as RFID tags which may be carried on a continuous backing web 21 similarly to the labels 20 as described, or indeed on other substrates which are stored by the storage module 12 and fed to the printing module 14 for printing.

The labels 20 or other patches or substrates need not be carried on a continuous elongate backing web 21, but may be severally fed to the printing module 14 for printing by a transporting mechanism other than the spool 23, 24 and guide rollers 25 described in the example.

In another embodiment, the printing module 14 need not be a thermal printing module 14 but printing may be effected by another print head which is operative to remove ink from a carrier ribbon 33 and to deposit the ink on a label 20 or other substrate at the printing station 28.

In another embodiment, to re-hand the printing apparatus 10, it may not be necessary to re-orientate the substrate storage and/or take-up spool 23, 24 of the storage module 12 as described, and nor may it be necessary re-orientate the ribbon supply and take-up spools 35, 36 of the printing module 14, or to reposition the print head 30 differently for right hand and left hand use.

1. A printing apparatus including a substrate storage module including first and second sides, and a printing module, the storage module including a store of substrates to be printed upon, and a transport mechanism for transporting the substrates to the printing module, and the printing module including a print head, a ribbon supply spool, a ribbon take-up spool, and ribbon drive mechanism for driving the ribbon relative to the print head, and wherein the printing module is locatable and operable when located at or adjacent either of first and second opposite sides of the storage module.

2. An apparatus according to claim 1 wherein the storage module includes a first connector part at each of the first and second opposite sides, and the printing module includes first and second surface which are positionable at or adjacent respective first or second sides of the storage module, each of the first and second surfaces including second connector parts which are each engageable with a respective first connector part to enable the printing apparatus to be operated with the printing module at either side of the storage module.

3. An apparatus according to claim 2 wherein the connector first and second connector parts when engaged, permit of electrical continuity between the storage and printer modules, for at least one of control purposes and to provide continuity of electrical power supply.

4. An apparatus according to claim 3 wherein a controller to control the functions of each of the storage module and the printing module is provided in one of the modules.

5. An apparatus according to claim 4 wherein the controller is provided in the storage module.

6. An apparatus according to claim 2 wherein each of the first and second storage module sides includes a first mounting formation and each first and second printing module surface includes a second mounting formation, first and second mounting formations being co-operable for mounting the printing module with respect to the storage module at or adjacent one or other of the first and second sides of the storage module.

7. An apparatus according to claim 1 wherein the printing module includes a print head which in use removes marking medium from a ribbon carrying marking medium, and deposits the marking medium onto a substrate.

8. An apparatus according to claim 7 wherein the print head of the thermal kind, including an array of printing elements which are selectively energisable under computer control to heat up and to remove pixels of marking medium from the ribbon.

9. An apparatus according to claim 7 wherein the print head is mounted so that the print head is orientated in a first position when the printing module is located at or adjacent the first side of the storage module, and oriented in a second position when the printing module is located at or adjacent the second side of the storage module.

10. An apparatus according to claim 9 wherein the print head mounting permits of the ready re-orientation of the print head so that the printing apparatus is readily re-configurable for operation at the second side of the storage module.

11. An apparatus according to claim 1 wherein the printing module includes a backing member to support the substrates during printing.

12. An apparatus according to claim 1 in which the substrate are patches which each have a face provided with adhesive by which the patches are releasably adhered to an elongate backing web.

13. An apparatus according to claim 12 wherein the patches and backing web are stored on a storage device, and the patches are transported on the backing web to the printing module where the patches are printed upon by the print head.

14. An apparatus according to claim 12 wherein the printing module includes a patch removal mechanism for removing patches from the backing web after printing, which mechanism may include a reversing roller and/or a beak.

15. An apparatus according to claim 14 wherein the backing web from which patches have been removed is taken up onto a take-up device of the storage module.

16. An apparatus according to claim 13 wherein the storage device is a storage spool and the take-up device where provided is a take-up spool.

17. An apparatus according to claim 16 wherein the backing web and patches are transported by rotating the take-up spool.

18. An apparatus according to claim 17 wherein the storage spool is simultaneously rotated with the take-up spool to transport the backing web and patches.

19. An apparatus according to claim 1 wherein the printing apparatus includes a patch applying module which is located relative to the printing module to receive printed patches and to apply them to articles.

20. An apparatus according to claim 19 wherein the patch applying module includes a first connector part which is in use, engaged with the second connector part of the printing module which is not engaged with a first connector part of the storage module.

21. A method of re-configuring a printing apparatus which includes a substrate storage module including first and second sides, and a printing module, the storage module including a store of substrates to be printed upon, and a transport mechanism for transporting the substrates to the printing module, and the printing module including a print head, a ribbon supply spool, a ribbon take-up spool, and ribbon drive mechanism for driving the ribbon relative to the print head, and wherein the storage module is locatable and operable and configured for use with the first surface of the printing module at or adjacent the first side of the storage module, the method including relocating the printing module so that the second surface of the printing module is at or adjacent the second side of the storage module.

22. A method according to claim 21 which includes disengaging a first connector part of the first side of the storage module from the second connector part at the first surface of the printing module, and after or upon relocating the printing module, engaging the second connector part of the second surface of the printing module with the first connector part of the second side of the storage module.

23. A method according to claim 21 which includes re-positioning the print head.
